(19) United States
(12) Patent Application Publication
(10) Pub. No.: US 2006/0231131 A1
(43) Pub. Date: Oct. 19, 2006

(54) Solar paver light

(76) Inventor: Mark C. Hain, Reno, NV (US)

Correspondence Address: HAUGEN LAW FIRM, SUITE 1130 - TCF TOWER, 121 SOUTH EIGHTH STREET, MINNEAPOLIS, MN, 55402, US

(21) Appl. No.: 11/108,316

(22) Filed: Apr. 18, 2005

(51) Int. Cl. H02N 6/00

(52) U.S. Cl. 136/244; 136/291

(57) ABSTRACT

A solar paver light has a housing defined by a bottom panel and side panel defining a top opening in the housing. A solar cell and power storage unit are contained within the housing to provide power to a light source. A tab extends from an exterior of the housing to provide a surface for engaging an adjacent tile, during installation of the solar paver light. One or more ridges extend from the exterior to provide a uniform spaced relationship between the solar paver light and adjacent tile and to allow for a filler material to be deposited in the space between the solar paver light and adjacent tile.

### FIELD OF THE INVENTION

The present invention relates generally to the field of in ground, concrete and paver lights, and more specifically to the improved structure and installation of solar powered paver lights.

### BACKGROUND OF THE PRIOR ART

Outdoor and garden lighting is in widespread use in many different types of environments. The present invention relates more specifically to outdoor paver lights, for use in illuminating a pathway or garden, driveway, deck or any substantially flat or level driving or walking surface. A unique problem with paver lights, as opposed to other ground installable light sources, is that a paver light is installable adjacent to a tile or block form, such as brick, stone, concrete, wood and the like. This poses additional problems that are not associated with the ground installable light sources found in the prior art.

Existing paver lights can be cumbersome to install and maintain where the light source must be connected to a power source. This involves underground wiring that is difficult to install, and even more difficult to access after the paver light and surrounding landscaping has been installed.

A number of ground installable lighting sources are described in the prior art, which utilize solar powered light sources.

U.S. Patent Appln. No. 2003/0090896 by Sooferian discloses a solar powered stepping stone that is arranged in a pathway with respect to additional stepping stones. The stepping stones are square in shape and have a housing with an upper portion having vertical sides with a periphery equal to that of the tile face. A lower portion of the housing is stepped to a smaller rectangular periphery.

U.S. Patent Appln. No. 2003/0137831 to Lin shows a cylindrical tile in combination with a solar lamp. The tile has smooth, vertical sides for installation in the ground.

U.S. Pat. No. D309,953 issued to Chien shows yet another solar powered light mounted within a tile. This tile is hexagonal in shape and has smooth vertical sides.

Although the above inventions solve the problem of cumbersome wiring as it relates to ground installable light sources, none of these references address the particular problems associated with paver lights. The above references are directed towards light sources that are individually mounted within a landscape. A paver light, on the other hand, is often mounted adjacent to a tile. The smooth vertical sides of the above references make the spacing, positioning and installation of the tile more difficult. Particularly, this makes it difficult to mount the tile so that it is both flush with the upper surface of an adjacent tile and evenly spaced therefrom.

A number of prior art references show features that are intended to assist in the positioning of ground installed lights.

U.S. Patent Appln. No. 2003/0053307 to Talamo et al. shows a horizontal flange extending along an entire side of the base structure of a light housing.

U.S. Pat. Nos. 5,072,345 and 4,984,139 issued to Goggia show a housing having a radial flange extending around the entire circumference of a light housing.

The above prior art references address the issue of positioning a ground installable light using a horizontal flange that extends across the housing of the light. The flanges are used to install the light within a filler material, such as concrete or bituminous, and are not intended to uniformly position the light source with respect to an adjacent tile. The use of a flange extending across an entire side of a light housing would be ineffective when used with a paver light. The reason is because the flange is likely to engage the adjacent tile, and thus prevent filler material from flowing below the flange. This may cause problems in the installation of the paver light.

An additional problem associated with paver lights, not addressed in the prior art, is that as the filler material, including grout or concrete or any other suitable material, is deposited in a narrow space between the paver light and adjacent tile. This can cause the paver light to hydraulic out of position, such as when the filler material is in the space below the paver light housing.

Further, the prior art does not disclose a method or feature for providing uniform positioning of a paver light with respect to an adjacent tile.

The present invention addresses these and additional problems associated with the prior art, as discussed with regards to the embodiments shown in the figures and discussed in the detailed description.

### SUMMARY OF THE INVENTION

The present invention provides a solar paver light having a housing defined by a bottom panel and a side panel to define a top opening. The housing contains a power cell arranged to collect solar power. A power storage unit collects and stores energy collected by the solar power cell. A light source is illuminated and powered by the power storage unit, and is activated via a timer or via a sensor that is activated by darkness and/or motion or any other such suitable means of activation.

A light emitting cover panel is positioned over the housing to protect the solar power cells and the components maintained within the housing. The light emitting cover panel allows solar energy to transmit therethrough to be captured by the solar power cells positioned within the housing. The light emitting cover also allows light from the light source to be emitted therethrough to an exterior of the housing when the light source is activated.

A tab extends from an exterior surface of the side panel, more particularly it may extend from a lower edge of the exterior surface, to provide a spacing and positioning guide when the solar paver light is installed adjacent to a decorative tile. One or more angled ridges also extend from an exterior surface of the side panel to provide a uniform and spaced relationship between the solar paver light and an adjacent decorative tile. The angled ridge or ridges also assist in the installation of the paver light by locking the light in place and keeping the light from hydraulicing out of position during installation, such as when a filler material is used.

### BRIEF DESCRIPTION OF THE DRAWINGS

FIG. 1 is a perspective view of a preferred embodiment of the present invention.

FIG. 2 is a cut away view of the invention from FIG. 1.

FIG. 3 is a perspective view of another embodiment of the present invention, in use.

FIG. 4 illustrates a second embodiment of the present invention.

FIG. 5 illustrates yet another embodiment of the present invention.

### DETAILED DESCRIPTION OF THE PREFERRED EMBODIMENTS

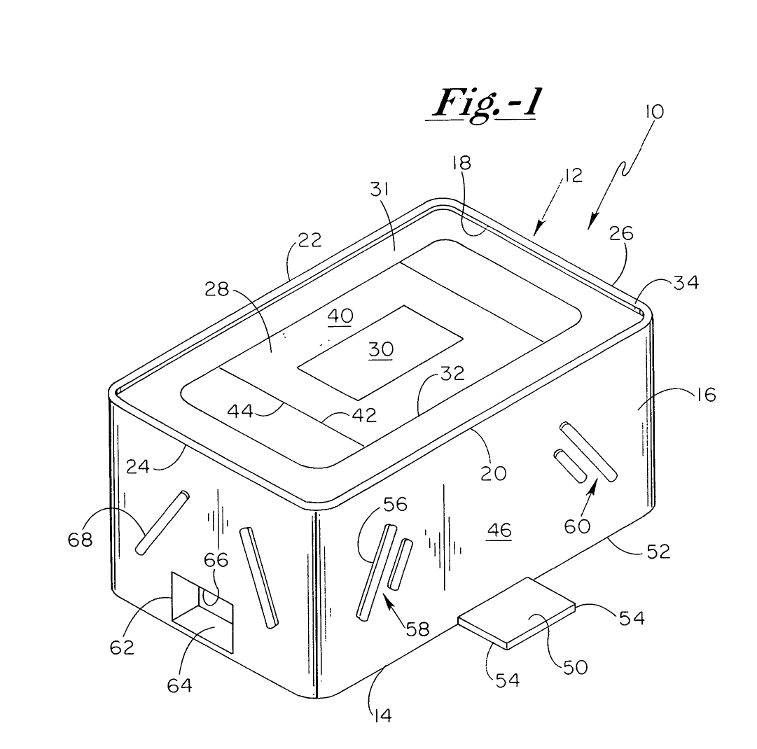

FIG. 1 illustrates a perspective view of a solar paver light 10 in accordance with the present invention. A housing 12 is shown having a bottom panel 14 and a side panel 16 defining a top opening 18 in the housing. The side panel in this embodiment comprises a pair of opposing side walls 20, 22 connected to each other by a pair of opposing end walls 24, 26.

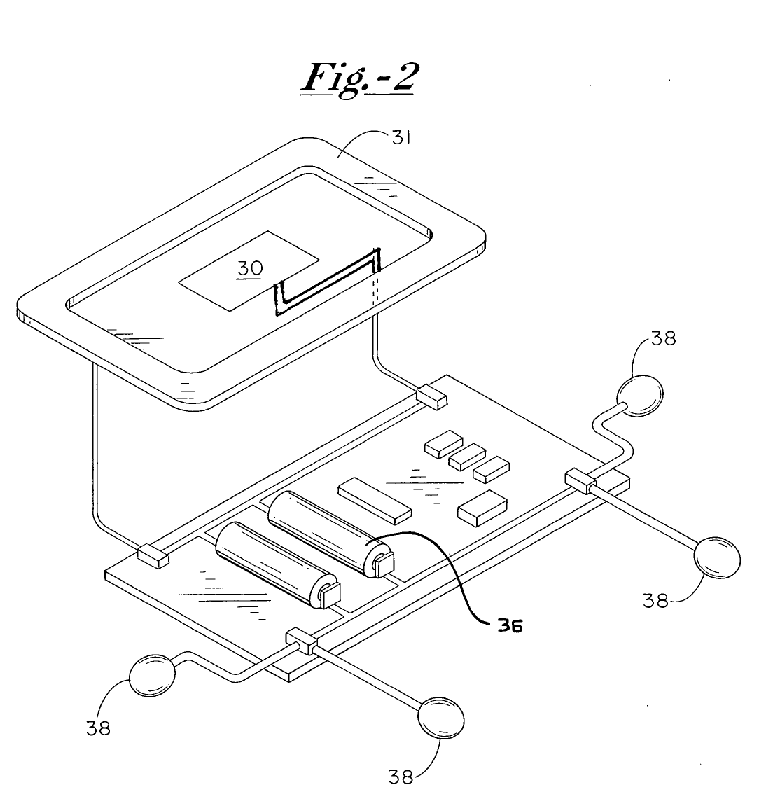

The plenum 28 defined by the bottom panel 14 and side panel 16 houses a solar power cell 30 or plurality of cells. As shown in more detail in FIG. 2, the solar power cells 30 may be alternatively configured and positioned within the housing 12. A solar power cell 30 is positioned within a central portion of the housing 12, and is raised towards the upper edge 34 of the side wall 20. As shown, a second solar power cell 31 may extend around an inner perimeter 32 of the housing 12, at an upper edge 34 of the side wall 20. Instead, a gasket may extend around the inner perimeter 32 or may extend coextensively or intermittently with portions of the second solar power cell 31.

A power storage unit 36 is positioned within the housing 12, beneath the power cell 30 in the present embodiment. The solar power storage unit 36 stores solar power collected by the solar power cells 30, 31. The solar power storage unit 36 in the present embodiment is a battery, however, any suitable power storage unit 36 capable of connecting to and collecting power may be utilized in accordance with the present invention.

A lighting source 38 is positioned within the housing 12 and is connected to the solar power storage unit 36. The solar power storage unit 36 supplies power to the lighting source 38 to illuminate the solar paver light 10. In the present embodiment, the lighting source 38 is positioned beneath the solar power cell 30. The housing 12 is made of a reflective material and/or color reflective in order to allow the light from the lighting source 38 to illuminate the housing 12 and to be emitted through the top opening 18 of the housing 12.

A light emitting cover 40 is provided to cover the housing 12 and solar power cells 30, 31 and protect them from the elements and from damage. The light emitting cover 40 may be transparent or translucent to allow solar energy to penetrate the cover 40 and to allow light illuminated from the light source 38 within the housing 12 to be emitted through the cover 40. The housing 12 has a mating portion 42 that is in alignment with a corresponding mating portion 44 of the light emitting cover 40 to allow the light emitting cover 40 to be positioned and removably secured to the housing 12. As shown in FIG. 1 the light emitting cover 40 is connected to the housing 12 by threading a screw through the mating portion 44 of the light emitting cover 40 and through the corresponding mating portion 42 of the housing 12.

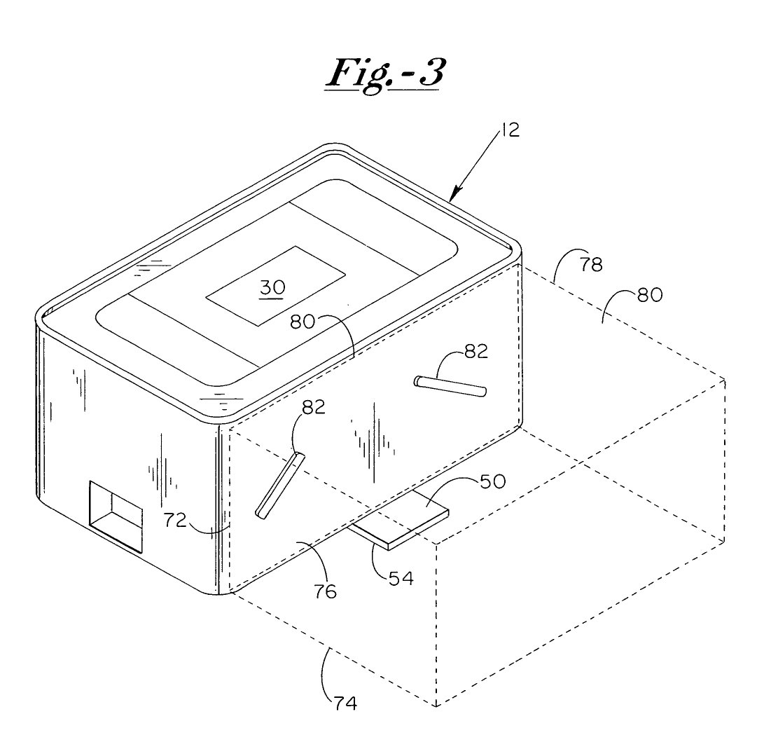

As shown in FIGS. 1 and 3, a tab 50 extends from a lower edge 52 of the side panel 16 to form a horizontal plane in a parallel relationship with respect to the plane defined by the bottom panel 14. The tab 50 extends from a lower portion of the side panel 16, and more particularly, from the lower edge 52 of the side panel 16. In the present embodiment, the tab 50 extends from a bottom side of the bottom panel 14. The tab 50 has terminating ends 54 such that the tab 50 is coextensive with only a portion of the length of the side panel 16 and corresponding side wall 20, 22 from which it extends. The tab is permanently secured to the bottom panel 14 by any suitable attachment means common in the art, or may be integrally formed therewith.

Also extending outwardly from the exterior surface 46 of the side panel 16 is at least a single ridge 56. In the embodiment shown in FIG. 1, a first set of angled ridges 58 extend from an upper portion of the side panel 16. A second set of angled ridges 60 are configured and arranged to extend from the side panel 16 in a mirrored relationship with respect to the first set of angled ridges 58, the ridges being angled downwardly as they extend towards the nearest opposing end wall 24, 26 of the housing 12.

The ridges 56 extend transversely with respect to the plane defined by the tab 50 such that the ridges 56 are at an oblique angle relative to the upper edge 34 and/or lower edge 52 of the side panel 16. In the embodiment shown, the opposing side walls 20, 22 each have a tab 50 and a first set of angled ridges 58 and a second set of angled ridges 60 extending from the exterior surface 46, as described above. The tabs and ridges may be integrally formed with the housing.

Also shown in FIGS. 1 and 3 is a niche 62 defined by a recessed portion 64 in the end wall 24 or 26 of the side panel 16. The niche 62 has an upper wall surface 66 that allows for an upward force to be applied against the upper wall 66, such as for access and removal of an installed solar paver light 10. Each end wall 24, 26 may have a niche defined therein for such access.

Also shown extending from an upper portion of the exterior surface 46 of the end walls 24, 26 are a pair of ridges 68 in mirror relationship to each other. The ridges 68 are angled to extend downwardly as they extend towards the nearest side wall 20, 22, transverse to the upper and lower edges 34 and 52, respectively, of the end walls, and forming an oblique angle with respect thereto.

In the embodiment shown in FIG. 3 a pair of ridges 56 are shown in mirror relationship to each other on the side panels 16. The end panels in this embodiment do not have ridges thereon.

In use, the solar paver light 10 may be installed adjacent a decorative tile 70 such as a brick, stone or concrete block, for example. It is preferable that the solar paver light 10 be substantially uniformly spaced from the side edge 72 of an adjacent tile 70. As shown in FIG. 3, the tab 50 and ridges 56 of the present invention are configured and arranged to facilitate such installation. The bottom edge 74 of an adjacent tile 70 is positioned to contact the top face 76 of the tab 50. This will ensure that the top surface 78 of the tile 70 is aligned in the same plane as with the cover 40 of the housing 12 to form a substantially planar pathway. The ridges 56 are positioned proximate or in contact with the side surface 72 of the tile 70 to provide a uniformed spaced relationship between the tile 70 and solar paver light 10.

A filler material such as grout or cement or sand is deposited in the space 80 between the solar paver light 10 and tile 70 to secure the relative positioning of the solar paver light 10 and tile 70. The ridges 56 provide a channel 82 for directing the flow of the filler material, and to ensure that the filler material is evenly deposited within the space 80, while maintaining the substantially uniformly spaced relationship between the solar paver light 10 and adjacent tile 70. The tab 50 ensures that the cover 40 of the solar paver light 10 and top surface 78 tile 70 are maintained in a planer relationship to each other.

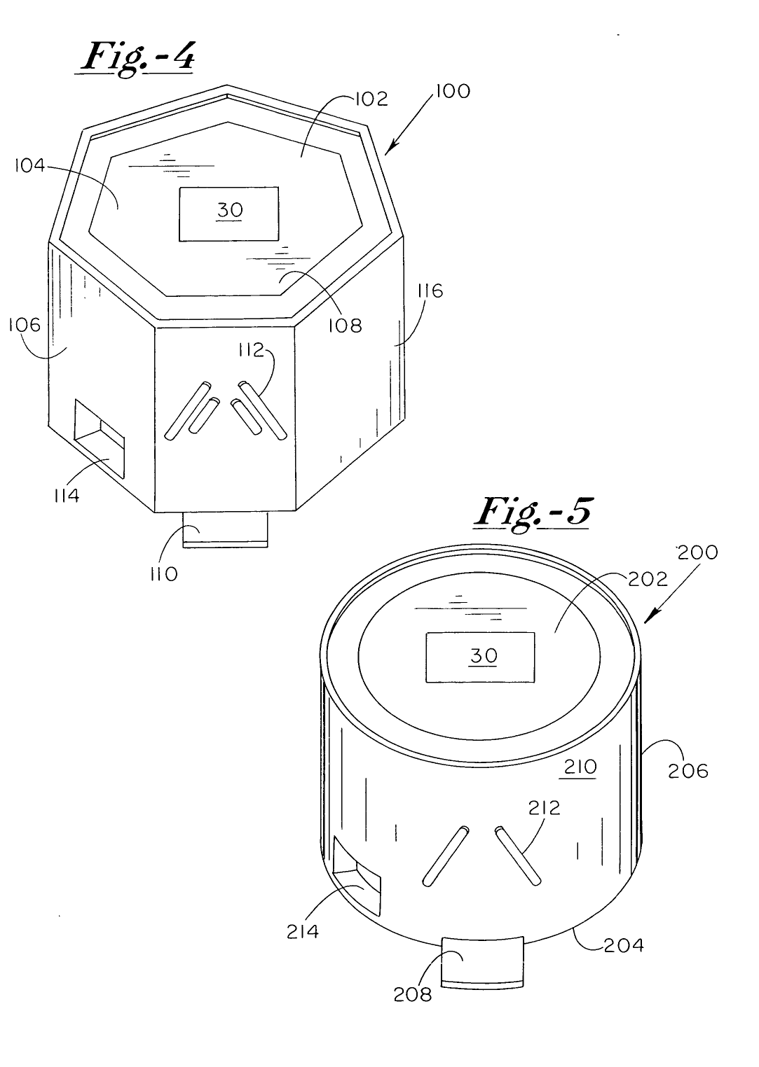

FIG. 4 illustrates another embodiment of the present invention. A solar paver light 100 is shown having a housing 102 having a bottom panel 104 and a plurality of side walls 106 surrounding the bottom panel 104 to define a plenum 108. Any one or more of the side walls 106 may include a tab 10 and/or may include one or more ridges 112 extending therefrom in accordance with the present invention. Any one or more side walls 106 may also or separately include a niche 114 and/or may include one or more ridges extending from an exterior surface 116 of the side wall 106 in accordance with the present invention.

FIG. 5 illustrates yet another embodiment of the present invention. A solar paver light 200 is shown having a housing 202 defined by a bottom panel 204 and a curved side panel 206. The curved side panel 206 may have one or more tabs 208 extending from an exterior surface 210 thereof, and may have one or more ridges 212 extending from an exterior surface 210 thereof, and may have one or more niches 214 recessed within the side panel 206 thereof, these features may be used in combination or individually configured and arranged in accordance with the present invention.

What is claimed is:

1. A paver light comprising:
a) a housing having a bottom panel and a side panel defining a top opening;
b) a light emitting cover positionable over said top opening of said housing; and
c) a tab extending from an exterior surface of said side panel.

2. The paver light in accordance with claim 1 further comprising a ridge extending from said exterior surface of said side panel, said ridge extending at an oblique angle with respect to said tab.

3. The paver light in accordance with claim 2 further comprising a solar power cell positioned within said housing.

4. The paver light in accordance with claim 3 further comprising a power storage unit positioned within said housing.

5. The paver light in accordance with claim 4 wherein said power storage unit is a battery.

6. The paver light in accordance with claim 4 further comprising a lighting source positioned within said housing, said lighting source powered by said power storage unit.

7. The paver light in accordance with claim 6 wherein said housing is a reflective color.

8. The paver light in accordance with claim 7 wherein said light emitting cover is transparent.

9. The paver light in accordance with claim 7 wherein said light emitting cover is translucent.

10. The paver light in accordance with claim 6 wherein said tab extends horizontally from said exterior surface of said side panel.

11. The paver light in accordance with claim 10 wherein said housing and said tab and said ridge are integrally formed.

12. The paver light in accordance with claim 11 wherein said tab is positioned at a lower portion of said side panel.

13. The paver light in accordance with claim 12 wherein said ridge is positioned at an upper portion of said side panel.

14. A solar paver light comprising:
a) a housing having a bottom panel, a pair of end panels and a pair of side panels configured to define an opening;
b) a cover panel configured to cover said opening of said housing;
c) solar energy collectors arranged within said housing to collect solar energy;
d) a solar power storage member positioned within said housing for receiving and storing solar energy from said solar energy collectors;
e) an illumination member for illuminating at least a portion of said solar paver light, the illumination member being powered by said solar power storage member;
f) a tab extending from a lower portion of an exterior surface of each of said pair of side panels;
g) a first angled ridge extending from an upper portion of said exterior surface of each of said pair of side panels;
h) a second angled ridge extending from said exterior surface of each of said pair of side panels, said second angled ridge being configured and arranged in a mirrored relationship with respect to said first angled ridge.

15. The solar paver light in accordance with claim 14 wherein at least one of said pair of end panels has a niche defined therein.

16. The solar paver light in accordance with claim 15 wherein said solar paver light is installed in concrete.

17. A method for installing a solar paver light comprising:
a) arranging said solar paver light on an installation surface, said solar paver light having a housing with a tab extending from a lower portion of said housing and a ridge extending from an upper portion of said side panel;
b) arranging a tile adjacent to said solar paver light such that a bottom surface of said tile is contacted by said tab and a side surface of said tile is positioned adjacent said ridge to define a spaced relationship between said solar paver light and said tile; and
c) depositing a filler material between said solar paver light and said tile to secure the relative positions of said solar paver light with respect to said tile.

18. The method in accordance with claim 17 wherein said tile is stone.

19. The method in accordance with claim 17 wherein said tile is brick.

20. The method in accordance with claim 17 wherein said ridges are angled to allow said filler material to flow along said side panel.
